(19) United States
(12) Patent Application Publication
(10) Pub. No.: US 2025/0367828 A1
(43) Pub. Date: Dec. 4, 2025

(54) Method for Automatically Setting Up a Safety Function Configuration for a Robot Device

(71) Applicant: ABB Schweiz AG, Baden (CH)

(72) Inventors: Christoph Byner, Mannheim (DE); Arne Wahrburg, Weiterstadt (DE); Bjoern Matthias, Bad Schönborn (DE); Debora Clever, Zwingenberg (DE); Fan Dai, Zwingenberg (DE); Florian Stuhlenmiller, Ladenburg (DE); Harald Staab, Neckargemünd (DE); Nuo Li, Mannheim (DE); Rene Kirsten, Fernwald (DE); Silke Klose, Bensheim (DE)

(73) Assignee: ABB Schweiz AG, Baden (CH)

(21) Appl. No.: 19/298,754

(22) Filed: Aug. 13, 2025

Related U.S. Application Data
(63) Continuation of application No. PCT/EP2023/054309, filed on Feb. 21, 2023.

(51) Int. Cl. B25J 9/16; B25J 13/08

(52) U.S. Cl. CPC B25J 9/1676; B25J 13/089

(57) ABSTRACT

A method for automatically setting up a safety function configuration for a robot device includes obtaining a distance information between at least one moving part of the robot device and a defined position point in an environment of the robot device; comparing the distance information with a minimum gap criterion that defines a minimum distance between the at least one moving part of the robot device and the defined position point in the environment of the robot device, determining automatically a corresponding safety function configuration for the robot device in a dedicated workspace area depending on a deviation of the distance information and the minimum gap criterion.

### CROSS-REFERENCE TO RELATED APPLICATIONS

The instant application claims priority to International Patent Application No. PCT/EP2023/054309, filed Feb. 21, 2023, which is incorporated herein in its entirety by reference.

### FIELD OF THE DISCLOSURE

The present disclosure generally relates to a method for automatically setting up a safety function configuration for a robot device.

### BACKGROUND OF THE INVENTION

In collaborative robot applications where physical contact between humans and the moving robot is not prevented; potential contact situations must be controlled properly using Power and Force Limiting (PFL) protection measures to render them harmless for the human.

Since the contact mechanics of a robot device differ significantly between crushing situations and free impact, reducing sufficiently the risk for each of these contact types requires the implementation of different measures or restrictions of the motion of the robot device.

Therefore, the risk assessment must identify potential contact hazards and distinguish with respect to their contact configuration, which can be either constrained (clamping, crushing) or unconstrained (free impact, bumping). Depending on the contact configuration, different safety functions or safety parameters must be applied to the robot device ensuring suitable risk mitigation.

Further, the risk assessment for a robot device must therefore identify and distinguish between areas in the robot's range of motion where clamping or crushing hazards exist (“clamping zones”), versus areas where, due to the absence of structural obstacles, potential contact can be of unconstrained nature only such that the human body part is free to recoil.

Preemptively limiting the manipulator speed and thereby its kinetic energy to a certain extent might sufficiently reduce the risk in unconstrained contact situations. In contrast, safeguarding of crushing or clamping hazards typically requires considerably lower robot speed as well as a limitation of the maximum contact force that the robot can exert.

Therefore, it is important for the safety of an operator that the robot device respects these limitations in the presence of such hazards, while otherwise exploiting the less restrictive limits for safeguarding of free impact is desirable to avoid unnecessary productivity losses.

For this purpose, the robot device needs information defining in which areas (or during which phases of the application) crushing hazards need to be considered, and in which areas only free impact can occur.

Currently, this is typically achieved through a manual definition of spatial zones and an assignment of the corresponding safety functions and parameters (e.g., speed and force supervision with the respective limits) in a safety configuration of the robot device. However, a manual configuration of safety functions to a robot device has the major disadvantage that the safety zones of the robot device cannot automatically adapt to changes in the robot's application, e.g. a new crushing hazard introduced by installing an additional feature on the robot device or in its environment, or to dynamically changing environment requirements for the robot device, e.g. vision-based applications where workpiece positions are not defined in advance. This makes the safety configuration of a robot device cumbersome and the entire production process in which the robot device is involved, expensive, and time-consuming.

### BRIEF SUMMARY OF THE INVENTION

The present disclosure generally describes an improved concept of automatically generating a safety function configuration for a robot device dynamically applicable to different production scenarios of the robot device.

In a first aspect, the disclosure describes a method for automatically setting up a safety function configuration for a robot device, comprising: obtaining a distance information, wherein the distance information is a distance between at least one moving part of the robot device and a defined position point in an environment of the robot device; comparing the distance information with a minimum gap criterion that defines a minimum distance between the at least one moving part of the robot device and the defined position point in the environment of the robot device; and determining automatically a corresponding safety function configuration for the robot device in a dedicated workspace area depending on a deviation of the distance information and the minimum gap criterion.

The present disclosure generally describes embodiments that use information about the application environment of the robot device or, more specifically, use information about the distance between the robot device (including its end-effector) and the application environment of the robot device, to automatically configure a safety function configuration of the robot device which incorporates defining at least one safety zone around the robot device.

By comparing the distance information obtained from e.g. an environment model and/or recorded via a sensor system connected to the robot device or providing sensory information to the robot device, e.g. during a trial run, with a minimum gap criterion, areas where crushing hazards exist can be easily identified and the required safety zones can be set up automatically in the safety configuration of the robot device.

A further distinction can be made by considering only accessible areas of the workspace of the robot device, as there is no risk of a physical contact in areas in which human access is prevented (through safeguards such as fences or other physical obstruction). Thus, limiting the robot speed is not necessary in a defined zone in the robot's workspace that is outside a human's reach

As an alternative embodiment, when safety-rated distance information is available during runtime of the application, it can be utilized to switch between the required settings for safeguarding of the different contact types directly, avoiding the need for setting up safety zones altogether.

Embodiments in accordance with the present disclosure advantageously include a PFL-related configuration for a robot device, which can be simplified. Further, case of use for users with any level of experience when setting up a safety function configuration for a robot device is improved, thus reducing time- and cost-consuming manual adaption of the corresponding safety function configuration of the robot device when the environment and/or the application of the robot device is dynamically changing.

### BRIEF DESCRIPTION OF THE SEVERAL VIEWS OF THE DRAWING(S)

FIG. 1 is a schematic flow-diagram of a method in accordance with the disclosure.

FIG. 2 is a schematic example of an automatic safety zone configuration according to a method of the present disclosure.

FIG. 3 is a schematic diagram for an exemplary automatic safety zone configuration with sensors on the robot device according to a method of the present disclosure.

FIG. 4 is a schematic diagram of an exemplary overlapping safety zone configuration according to a method of the present disclosure.

### DETAILED DESCRIPTION OF THE INVENTION

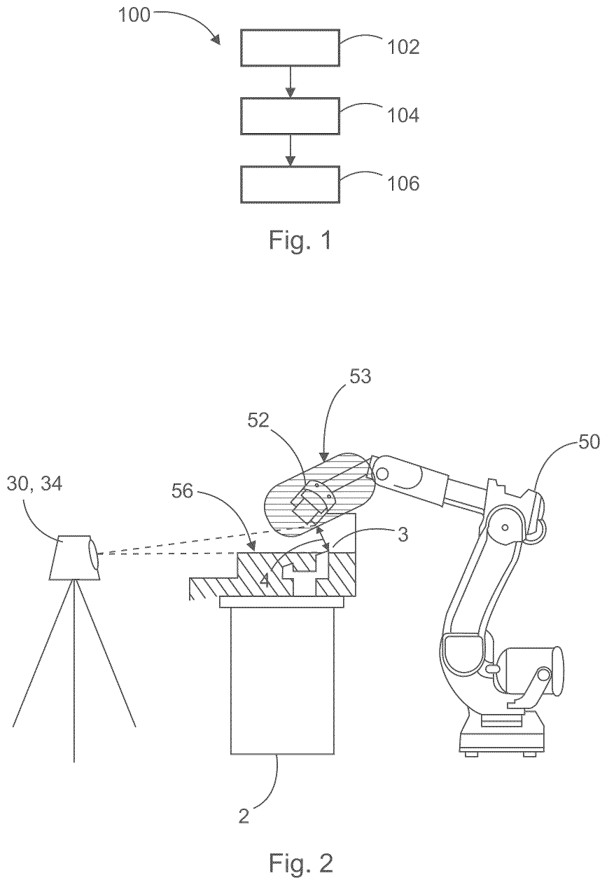

FIG. 1 illustrates a schematic flow-diagram of a method 100 of the present invention. In a first step 102, a distance information 4 is obtained, wherein the distance information 4 is a distance between at least one moving part 52 of the robot device 50 and a defined position point 3 in an environment 2 of the robot device 50. Alternatively, the distance information 4 may also be regarded as a minimum distance between at least one moving part 52 of the robot device 50 and an object in the environment 2 of the robot device 50.

In this respect, it is worth noting that the defined position point 3 is the point or location in the environment 2 of the robot device 50 that is closest or located next to the robot device 50. Further, it should be noted that the environment 2 of the robot device 50 does also mean one or more objects in the environment 2 of the robot device 50. In a second step 104, the distance information 4 is compared with a minimum gap criterion that defines a minimum distance between the at least one moving part 52 of the robot device 50 and the defined position point 3 in the environment 2 of the robot device 50. In a third step 106, a corresponding safety function configuration is automatically determined for the robot device 50 in a dedicated workspace area depending on a deviation of the distance information 4 and the minimum gap criterion.

In this way, a location and dimension of required safety zones around the robot device 50 can be automatically detected or determined. Within safety zones with distances below the minimum gap, safety functions and limits required for safeguarding of crushing situations would automatically be applied.

Optionally, the step 106 of determining the safety function configuration comprises flexibly applying at least a safety function to the robot device 50 depending on at least one of a position parameter of the at least one robot device 50, an adapted functionality of the robot device 50 or an adapted environment parameter of the robot device 50, wherein the adapted environment parameter comprises the environment information of the environment 2 in the dedicated workspace area 54 (see FIG. 4) of the robot device 50.

FIG. 2 illustrates a schematic example of an automatic safety zone configuration according to a method of the present invention. In the embodiment of FIG. 2, the sensor system 30 is a robot-external distance (proximity) sensor 34 that provides a distance information 4 between a moving part 52 of the robot device 50 and a defined position point 3 in the environment 2 of the robot device 50. The distance information 4 obtained by the sensor 34 in FIG. 2 is then compared with a minimum gap criterion that defines a minimum distance between the moving part 52 of the robot device 50 and the defined position point 3 in the environment 2 of the robot device 50.

The sensor system 30 provides at least one piece of information that is one of an environment-related information of the environment 2 of the robot device 50 and/or an information of an exposed body region of a human in a dedicated workspace area 54 (see FIG. 4) of the robot device 50. The corresponding safety function configuration for the robot device 50 which is schematically indicated in FIG. 2 by safety zone 56 in the dedicated workspace area around the robot device 50 depends then on a deviation of the distance information 4 and the minimum gap criterion.

As an example, suitable minimum gaps to prevent crushing of different body parts are specified in ISO 13854 (e.g. ≥120 mm to prevent crushing of the human arm); dimensions of the automatically configured zones should in addition include a margin to account for reaction and stopping distances of the robot in case of a failure. In areas where the distance is larger than the respective minimum gap, the less restrictive limits for safeguarding of free impact apply. For both types of contact, assumptions on the potentially exposed human body regions are required to determine suitable robot motion limits, in particular, maximum speeds and maximum contact forces. In most cases, it will be adequate to resort to worst-case assumptions, e.g. choosing the parameters for crushing based on the ISO/TS 15066 biomechanical limits for hands and fingers/for unconstrained contact those for the human chest.

The safety zone 56 as shown in FIG. 2 and FIG. 4 is optionally flexibly configurable depending on at least a geometric parameter or an actual detected geometric parameter of the moving part 52 of the robot device 50. Optionally, also a detected environment parameter of the robot device 50 may be used to configure the safety zone 56.

The geometric parameter, the detected environment parameter or the environment-related parameter may include an information of an additional technical feature, e.g. a new tooling device, installed at the robot device 50 that changes a movement radius of the robot arm (moving part) or/and a geometry of the robot arm of the robot device 50.

The detected environment parameter may, however, also apply when an obstacle in the environment of the robot changes (is added or removed) and then this environment-related information is transferred to the robot device for configuring a new safety function configuration or a safety zone around the robot device 50.

In FIG. 2, the moving part 52 of the robot device 50 has a virtually definable buffer area 53 that is applied or located around a limited or defined space or region of the moving part 52 of the robot device 50. The buffer area 53 can be regarded as an encapsulation of the moving part 52 of the robot device 50 and allows to obtain the required distance information 4 in an easier way and helps to reduce processing load when obtaining said distance information 4.

The distance information 4 can be obtained in two different operation scenarios or operation modes of the robot device 50. In a first operation mode, the distance information 4 is obtained at run-time during a production mode of the robot device 50. During the run-time mode, the use of safety-rated sensors in the sensor system 30 is required, since the controller of the robot device 50 will enable/disable safety functions automatically based on this safety information. In this respect, the distance information 4 obtained is a safety-related distance information 4 provided by the sensor system 30. Further, in run-time mode, the distance between the moving part 52 of the robot device 50 and any obstacles or the environment 2 can be monitored permanently.

This information is then used to switch to a more restrictive “crushing” safety configuration setting directly if the measured distance falls below the minimum gap, without the need for a predefined zone or an environment model. It should be noted again that sensors used for this purpose must provide safety-rated information on the distance (or at least on the presence or absence of obstacles within the configured minimum gap). Also, an information on the exposed body regions is useful and mandatory when operating the robot device at run-time, e.g. worst-case assumptions or specified by an operator.

Permanent distance monitoring would then in an advantageous way allow for automatic adaptation of robot motion to changes in the application environment, without the need for reconfiguration, making this approach suitable also for applications in which robot paths are not defined in advance, e.g. if motion is adjusted based on input from sensors such as vision systems. It is noted that following this approach, a collision with the robot using the “free impact” limits is prevented entirely, since also a human body part approaching closer than the minimum gap will trigger a switch to the “crushing” limits. It can therefore be interpreted as a combination of the protective principles PFL and Speed and Separation Monitoring (SSM).

In a second operation mode, the distance information 4 is obtained during the trial run of a programmed production cycle of the robot device 50 deployed in the environment 2 which is an application environment in this operation mode. Further, the distance information 4 can also be obtained during a simulation of the programmed production cycle in a simulation environment.

During commissioning, using distance information 4 recorded in the trial run only supports the user with the configuration of a safety zone for the robot device 50. Therefore, any (also non-safety-rated) sensor in the sensor system 30 can be used. Therefore, the user is responsible for validating and applying the generated safety configuration of the robot device 50.

The distance information can be obtained by using a mathematic 3D-model of the robot device 50. The 3D-model additionally includes the environment-related information of the environment 2 of the robot device 50, e.g. a barrier, an obstacle in the vicinity of the robot device 50 or in the working area of the robot device 50.

The 3D-model of the robot device 50 may be a CAD-model originating from the engineering phase of the robot device. Alternatively, this 3D-model could be established based on sensor data from the physical robot station, using e.g. a 3D camera system, LIDAR or photogrammetry. Based on this model, information about the distance between the manipulator (incl. tooling, workpiece) geometry of the robot device and the environment 2 can be extracted for the programmed robot motion of the robot device 50. Instead of considering the actual geometries of moving parts of the robot linkage, tools or workpieces, optionally, geometry primitives such as buffer area 53 in FIG. 2 which encapsulate moving parts 52 of the robot device 50 can be used to reduce computational load when calculating distances.

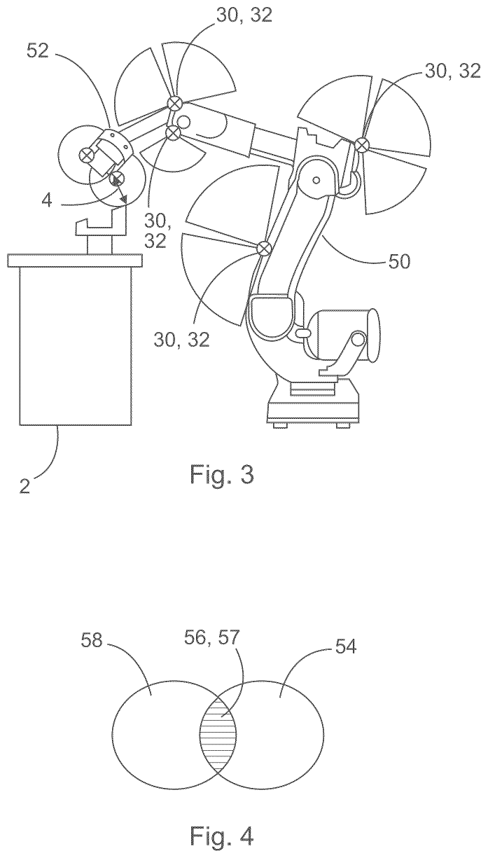

FIG. 3 illustrates a schematic example of an automatic safety zone configuration with sensors on the robot device according to a method of the present invention. The robot device 50 in FIG. 3 comprises a sensor system 30 that has a plurality of robot-internal distance (proximity) sensors 32 installed at various positions on the robot device 50. The distance information 4 is then obtained either during a trial run only (for offline auto-configuration of zones) or permanently in the deployed application (online) for switching automatically between different safety functions/parameters (without the need for zone configuration).

FIG. 4 illustrates a schematic example of an overlapping safety zone configuration according to a method of the present invention. The FIG. 4 shows an area 58 accessed by a human and a working space area 54 of the robot device 50. The intersection between both areas is the overlapping zone part 57 that corresponds to the workspace area 56 of the robot device 50.

The overlapping zone part 57 can be for example applied to the following scenario: If a 3D-model of the robot device or the robot station 50 is available which may include environment-related information 2 on obstacles that restrict the reach of a human (e.g. barriers, robot mounted on table), the safety distances may be applied, e.g. according to ISO 13857, to determine the areas that can be accessed by a human safely without the risk of contacting the robot device 50. By creating a spatial representation of the area 58 accessed by humans, the intersection 57 with the robot workspace 54 can be determined and used to set up a configured and optimized safety zone in the overlapping part only. Optionally, during this procedure of finding the overlapping zone part 57, anthropometric data of different body parts, e.g. compare EN 547-3, can be utilized to determine the exposed body parts and respect their corresponding limits from ISO/TS 15066. In this way, a customized and optimal safety zone for the robot device can be configured in an efficient way.

According to an example, the distance information is obtained by at least one sensor system, wherein the at least one sensor system provides at least one information that is one of an environment-related information of the environment of the robot device and/or an exposed body region of a human in a dedicated workspace area of the robot device. Therein, the advantage is achieved that a more detailed safety function configuration of the robot device can be applied to the robot device that better respects the environment of the robot device resulting in a more efficient operation of the robot device.

According to an example, the distance information is a safety-related distance information provided by the at least one sensor system. Therein, the advantage is achieved that the safety function configuration of the robot device is generated in an efficient way.

According to an example, the sensor system is a robot-internal sensor system that is directly applied on the robot device and/or the sensor system is a robot-external sensor-system that is applied in a certain distance to the robot device. The advantage is achieved that sensory information is provided in an efficient manner to the robot device depending on the environment or application of the robot device.

According to an example, the distance information is obtained by a mathematic 3D-model of the robot device alone or wherein the 3D-model additionally includes the environment-related information of the environment of the robot device. The advantage is generating a more realistic and optimized safety function configuration of the robot device allowing to operate the robot device in an efficient and optimal manner.

According to an example, an actual geometric parameter of the at least one moving part of the robot device is used for obtaining the distance information. In this way, the advantage of obtaining a precise distance information is achieved resulting in an optimal or optimized safety function configuration of the robot device.

According to an example, a defined buffer area around at least one moving part of the robot device is used for obtaining the distance information. The advantage is achieved that a computational or processing load when calculating distances for a safety function configuration for the robot device can be reduced.

According to an example, the distance information is obtained at run-time during a production mode of the robot device. The advantage is achieved that the safety function configuration of the robot device can be adapted without the need of stopping operation of the robot device or operation of the robot device which optimizes the production process of the robot device. In such a scenario, the use of safety-rated sensors is required, since the controller of the robot device will enable or disable certain safety functions automatically based on this information.

According to an example, the distance information is obtained during a trial run of a programmed production cycle of the robot device deployed in the environment which is an application environment. The advantage achieved is that a safety configuration is generated automatically and that a safety zone around the robot device is set up automatically. A further advantage is that a safety function configuration can be adapted to a users' needs before the robot device is used in a certain production scenario, e.g. by an external customer at another working place or production site. Further, the application design can be tested and adjusted accordingly. In said trial run scenario, the sensor system does not need to have safety-related sensors to obtain the distance information, resulting in a less complex and cost-efficient robot device.

According to an example, the step of determining a safety function configuration comprises flexibly applying at least a safety function to the robot device depending on at least one of a position parameter of the at least one robot device, an adapted functionality of the robot device or an adapted environment parameter of the robot device, wherein the adapted environment parameter comprises the environment information of the environment in the dedicated workspace area of the robot device. The advantage is achieved that a more customized safety function configuration of the robot device can applied to the robot device when incorporating the environment of the robot device resulting in an optimized production operation of the robot device.

According to an example, the step of determining a safety function configuration comprises setting up at least one safety zone around the robot device that has at least one dedicated safety function that corresponds to the deviation of the obtained distance information from the minimum gap criterion. The advantage is achieved that a customized safety zone around the robot device can be generated in an efficient manner adapted to the detected environment of the robot device.

According to an example, the at least one safety zone is flexibly configurable depending on at least a geometric parameter of the at least one moving part of the robot device and/or the detected environment parameter of the robot device. The advantage is achieved that a customized safety zone around the robot device can be generated in an efficient manner adapted to the detected environment of the robot device.

According to an example, the at least one safety zone comprises an overlapping zone part that is the result of an intersection of the dedicated workspace area of the robot device and an area that is accessed by a human. The advantage achieved is that customized safety zones can be efficiently generated allowing the maximize the robot device' workspace area and resulting in an optimized operation of the robot device.

In a second aspect of the present invention, a computer is provided comprising a processor configured to perform the method of the preceding aspect.

In a third aspect of the present invention, there is provided a computer program product comprising instructions which, when the program is executed by a computer processor, causes the computer to perform the method of any of the first and second aspects.

In a fourth aspect of the present invention, a machine-readable data medium and/or download product containing the computer program of the third aspect.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SYMBOLS

100 Method
102 Obtaining
104 Comparing
106 Determining
2 Environment of the robot device/Obstacle
3 Position point
4 Minimum distance between robot device and environment
30 Sensor system
32 Robot-internal distance sensor
34 Robot-external distance sensor
50 Robot device
52 (Moving) Part of the robot device
53 Buffer area
54 Workspace area
56 Safety zone
57 Overlapping zone part
58 Area accessed by a human

What is claimed is:

1. A method for automatically setting up a safety function configuration for a robot device, comprising:
obtaining a distance information, wherein the distance information is a distance between at least one moving part of the robot device and a defined position point in an environment of the robot device;
comparing the distance information with a minimum gap criterion that defines a minimum distance between the at least one moving part of the robot device and the defined position point in the environment of the robot device;
automatically determining a corresponding safety function configuration for the robot device in a dedicated workspace area depending on a deviation of the distance information and the minimum gap criterion.

2. The method of claim 1, wherein the distance information is obtained by at least one sensor system, wherein the at least one sensor system provides at least one piece of information that is one of an environment-related information of the environment of the robot device and/or an exposed body region of a human in a dedicated workspace area of the robot device.

3. The method of claim 1, wherein the distance information is a safety-related distance information provided by the at least one sensor system.

4. The method of claim 2, wherein the sensor system is a robot-internal sensor system that is directly applied on the robot device and/or the sensor system is a robot-external sensor-system that is applied in a certain distance to the robot device.

5. The method of claim 1, wherein the distance information is obtained by a mathematic 3D-model of the robot device alone or wherein the 3D-model additionally includes the environment-related information of the environment of the robot device.

6. The method of claim 1, wherein an actual geometric parameter of the at least one moving part of the robot device is used for obtaining the distance information.

7. The method of claim 1, wherein a defined buffer area around at least one moving part of the robot device is used for obtaining the distance information.

8. The method of claim 1, wherein the distance information is obtained at run-time during a production mode of the robot device.

9. The method of claim 1, wherein the distance information is obtained during a trial run of a programmed production cycle of the robot device deployed in the environment which is an application environment.

10. The method of claim 1, wherein determining a safety function configuration comprises flexibly applying at least a safety function to the robot device depending on at least one of: a position parameter of the at least one robot device, an adapted functionality of the robot device; or an adapted environment parameter of the robot device; and wherein the adapted environment parameter comprises the environment information of the environment in the dedicated workspace area of the robot device.

11. The method of claim 1, wherein determining a safety function configuration comprises setting up at least one safety zone around the robot device that has at least one dedicated safety function that corresponds to the deviation of the obtained distance information and the minimum gap criterion.

12. The method of claim 10, wherein the at least one safety zone is flexibly configurable depending on at least a geometric parameter of the at least one moving part of the robot device and/or the detected environment parameter of the robot device.

13. The method of claim 10, wherein the at least one safety zone comprises an overlapping zone part that results from an intersection of the dedicated workspace area of the robot device and an area that is accessible by humans.

14. A computer program product comprising instructions which, when the computer program is executed by a computer processor, causes the computer to perform a method for automatically setting up a safety function configuration for a robot device, comprising:
instructions for obtaining a distance information, wherein the distance information is a distance between at least one moving part of the robot device and a defined position point in an environment of the robot device;
instructions for comparing the distance information with a minimum gap criterion that defines a minimum distance between the at least one moving part of the robot device and the defined position point in the environment of the robot device; and
instructions for automatically determining a corresponding safety function configuration for the robot device in a dedicated workspace area depending on a deviation of the distance information and the minimum gap criterion.
